(19) United States
(12) Patent Application Publication
(10) Pub. No.: US 2022/0252703 A1
(43) Pub. Date: Aug. 11, 2022

(54) TRANSMISSION DEVICE FOR AN OPTICAL MEASUREMENT APPARATUS FOR DETECTING OBJECTS, LIGHT SIGNAL DEFLECTION DEVICE, MEASUREMENT APPARATUS AND METHOD FOR OPERATING A MEASUREMENT APPARATUS

(71) Applicant: Valeo Schalter und Sensoren GmbH, Bietigheim-Bissingen (DE)

(72) Inventor: Ho-Hoai-Duc Nguyen, Bietigheim-Bissingen (DE)

(73) Assignee: Valeo Schalter und Sensoren GmbH, Bietigheim-Bissingen (DE)

(21) Appl. No.: 17/629,179

(22) PCT Filed: Jul. 21, 2020
(86) PCT No.: PCT/EP2020/070529

§ 371 Date: Jan. 21, 2022

(30) Foreign Application Priority Data
Jul. 25, 2019 (DE) 10 2019 120 162.4

(51) Int. Cl. G01S 7/4865; G01S 17/931

(52) U.S. Cl. CPC G01S 7/4865; G01S 17/931

(57) ABSTRACT

The invention relates to a transmission device (24) for an optical measurement apparatus (12) for detecting objects (18) in a monitored region (16), a light signal deflection device (34, 40), a measurement apparatus (12) and a method for operating a measurement apparatus (12). The transmission device (24) comprises at least one transmitter light source (30) for emitting light signals (20) and at least one light signal deflection device (34) for deflecting the light signals (20) into at least one monitored region (16) of the measurement apparatus (12). The at least one light signal deflection device (34) has at least one deflection region (42a), which can act on the light signals (20) in direction-changing fashion and depending on an incidence (52) of the light signals (20). Furthermore, the transmission device (24) has at least one driving device (50), by means of which the at least one light signal deflection device (34) can be moved to change an incidence (52) of the light signals (20) on the at least one deflection region (42a). At least two deflection regions (42a) are arranged one behind the other in the beam path of the light signals (20). At least one deflection region (42a) has at least one diffractive structure, which has the action of an optical lens. The transmitter deflection regions (42a) are implemented for example on opposite sides of a rectangular, flat substrate (44). The transmitter deflection regions (42a) each extend as strips over almost the entire width of the substrate (44) transversely to the axis (46). The receiver light signal deflection device (40) is constructed analogously to the transmitter light signal deflection device (34). A position detection device (60) comprises a position region (62) for example in the form of a diffractive structure, for example a diffractive optical element, and an optical position detector (66). A pivoted position of the substrate (44) and thus of the transmitter light signal deflection device (34) and of the receiver light signal deflection device (40) can be determined by the position detection device (60).

### TECHNICAL FIELD

The invention relates to a transmission device for an optical measurement apparatus for capturing objects in a monitoring region,
having at least one transmitter light source for sending light signals,
having at least one light signal redirection device for redirecting the light signals into at least one monitoring region of the measurement apparatus, wherein the at least one light signal redirection device has at least one redirection region that can act on the light signals in dependence on an incidence of the light signals so as to change their direction,
and having at least one drive device, with which the at least one light signal redirection device can be moved to change an incidence of the light signals on the at least one redirection region.

The invention furthermore relates to a light signal redirection device for an optical measurement apparatus for capturing objects in a monitoring region, wherein the light signal redirection device has at least one redirection region that can act on light signals in dependence on an incidence of the light signals so as to change their direction.

The invention additionally relates to an optical measurement apparatus for capturing objects in a monitoring region,
having at least one transmission device for sending light signals,
having at least one receiving device with which light signals that have been reflected at objects that may be present in the monitoring region can be received,
having at least one control and evaluation device, with which the at least one transmission device and the at least one receiving device can be controlled and with which light signals received can be evaluated,
having at least one light signal redirection device for redirecting light signals, wherein the at least one light signal redirection device has at least one redirection region that can act on the light signals in dependence on an incidence of the light signals so as to change their direction,
and having at least one drive device, with which at least one redirection region can be moved to change an incidence of the light signals on the at least one redirection region.

The invention furthermore relates to a method for operating an optical measurement apparatus for capturing objects in a monitoring region, in which light signals are generated with at least one transmitter light source, the light signals are sent into the monitoring region, and light signals reflected in the monitoring region are received with at least one receiver, wherein respective directions of at least some of the light signals with at least one redirection region of at least one light signal redirection device are changed in dependence on an incidence of the light signals on the at least one redirection region and the at least one redirection region is moved for setting an incidence of the light signals on the at least one redirection region using at least one drive device.

### PRIOR ART

WO 2012/045603 A1 discloses a redirection mirror arrangement for an optical measurement apparatus. The optical measurement apparatus comprises a housing having a base plate. A transmission window, through which for example pulsed laser light is emitted, and a receiving window, through which laser light that has been reflected by objects in a monitoring region is received, have been disposed in the housing. A transmission unit, a receiver unit and a redirection mirror arrangement are arranged in the housing. The redirection mirror arrangement comprises a transmission mirror unit having two transmission redirection mirrors, which are arranged with a radial distance on a carrier plate in a common horizontal plane, and a receiving mirror unit having two receiving redirection mirrors, which are mounted with a radial distance in each case on one side of a carrier body. The transmission mirror unit and the receiving mirror unit are arranged with an axial distance from one another on a common rotatable pivot. A drive unit driving the rotatable pivot is arranged substantially in the space between the two transmission redirection mirrors. The fixed optical transmitter generates pulsed laser beams, which are redirected via the rotary transmission mirror unit and emitted through the transmission window into the region to be monitored.

The invention is based on the object of designing a transmission device, a light signal redirection device, an optical measurement apparatus, and a method of the type mentioned in the introductory part, in which redirection of the light signals into the monitoring region and/or out of the monitoring region can be simplified. In particular, the aim is to simplify the outlay in terms of components, assembly and/or adjustment and/or to improve reliability, in particular service life. Alternatively or additionally, the aim is to achieve an enlargement of the field of view and/or an improvement of the resolution.

### DISCLOSURE OF THE INVENTION

According to the invention, this object is achieved in the transmission device in that at least two redirection regions are arranged one behind another in the beam path of the light signals and at least one redirection region has at least one diffractive structure which has the effect of an optical lens.

According to the invention, the at least two redirection regions are arranged one behind another with respect to the beam path of the light signals. In this way it is possible, depending on the incidence of the light signals on a first redirection region, which is a front redirection region in the beam direction of the light signals, to direct the light signals onto a rear, second redirection region using the front redirection region.

According to the invention, at least one diffractive structure is used to refract the light signals and thereby change and/or set their direction. Diffractive structures can be easily realized and managed. An adjustment outlay can be reduced compared to known redirection mirrors. The requirements in terms of the quality of the light signals can be correspondingly lowered. Furthermore, diffractive structures can be individually adapted to achieve the desired direction-changing effect on the light signals.

As is known, diffractive structures are structures at which light beams, in particular laser beams, can be shaped. This is accomplished in the form of diffraction at optical gratings. In this case, the diffractive structures can be designed individually. They can be implemented in a manner such that the beam direction of an incident light beam is accordingly changed by the diffractive structure in dependence on the angle of incidence and/or a point of incidence on the diffractive structure. Diffractive structures can be operated in transmission.

At least one redirection region can advantageously be at least one diffractive structure which has the effect of an optical lens. Optical lenses have the effect that light passing through them is refracted and thus diverted toward the center of the light beam or scattered outwards. In this way it is possible with the corresponding diffractive structure to implement a defined refraction of the light signals, analogously to an optical lens.

The invention can be used to implement an optical measurement apparatus having a long-lasting and maintenance-free light signal redirection device. The light signal redirection device can furthermore be designed in a simple and compact manner. It is thus possible to achieve high flexibility without the need for a complex optical design. It is furthermore possible using the measurement apparatus according to the invention to capture a large field of view with a high resolution. For example, it is thus possible to reduce a requirement regarding large lenses on the transmission side or the receiver side.

Using the at least one drive device, the at least one light signal redirection device is moved to change an incidence of the light signals on the at least one redirection region. The incidence is characterized by the angle of incidence and/or the point of incidence at which the light signal is incident on the at least one redirection region. To change the incidence, either the angle of incidence or the point of incidence or both can be changed.

The angle of incidence can advantageously be changed by way of rotating or pivoting the at least one redirection region relative to the beam direction of the incident light signal. In this case, either the at least one redirection region or the transmitter light source or both can be rotated or pivoted.

The point of incidence can advantageously be changed by way of displacement, in particular using linear displacement, of the at least one redirection region relative to the beam direction of the incident light signal. In this case, the displacement can advantageously be performed transversely, in particular perpendicularly, to the beam direction of the incident light signal. In this case, either the at least one redirection region or the transmitter light source or both can be displaced.

The incidence of the light signals on at least one redirection region can be direct or indirect. In particular, a light signal coming from the transmitter light source can be directed onto the at least one redirection region indirectly with the aid of at least one optically effective element that is connected upstream. Additionally or alternatively, the light signal can be directed onto at least one rear redirection region with the aid of at least one redirection region that is a front redirection region as viewed in the beam direction.

Advantageously, at least one emitted light signal can be realized in the form of a light pulse. A start and an end of a light pulse can be determined, in particular measured. In this way, it is possible in particular to determine light travel times.

Advantageously, at least one light signal can also contain further information. For example, a light signal can in particular be encoded. In this way, it is easier to identify it and/or for it to carry along corresponding information.

The optical measurement apparatus can advantageously operate in accordance with a time-of-flight method, in particular a light pulse time-of-flight method. Optical measurement apparatuses operating in accordance with the light pulse time-of-flight method can be designed and referred to as time-of-flight (TOF) systems, light detection and ranging (LiDAR) systems, laser detection and ranging (LaDAR) systems or the like. Here, a time of flight from the emission of a light signal using the transmission device and the receipt of the corresponding reflected light signal using a corresponding receiving device of the measurement apparatus is measured, and a distance between the measurement apparatus and the detected object is ascertained therefrom.

Advantageously, the optical measurement apparatus can be designed as a scanning system. In this context, a monitoring region can be sampled, that is to say scanned, with light signals. To this end, the beam directions of the corresponding light signals can be pivoted, as it were, over the monitoring region. At least one light signal redirection device is used in this case.

Advantageously, the optical measurement apparatus can be designed as a laser-based distance measurement system. The laser-based distance measurement system can have, as the transmitter light source, at least one laser, in particular a diode laser. The at least one laser can be used to transmit in particular pulsed laser signals as light signals. The laser can be used to emit light signals in frequency ranges that are visible or not visible to the human eye. Accordingly, at least one receiving device can have a detector designed for the frequency of the emitted light, in particular an (avalanche) photodiode, a diode array, a CCD array or the like. The laser-based distance measurement system can advantageously be a laser scanner. A laser scanner can be used to sample a monitoring region with in particular pulsed laser signals.

The invention can be used advantageously in a vehicle, in particular a motor vehicle. The invention can advantageously be used in a land-based vehicle, in particular a passenger vehicle, a truck, a bus, a motorcycle or the like, an aircraft and/or a watercraft. The invention can also be used in vehicles that can be operated autonomously or at least partially autonomously. The invention can also be used in a stationary measurement apparatus.

The measurement apparatus can be used to capture standing or moving objects, in particular vehicles, persons, animals, plants, obstacles, road unevennesses, in particular potholes or rocks, roadway boundaries, free spaces, in particular free parking spaces, or the like.

Advantageously, the optical measurement apparatus can be part of a driver assistance system and/or of a chassis control system of a vehicle or be connected thereto. In this way, the vehicle can be operated partially autonomously or autonomously.

In an advantageous embodiment, the at least two redirection regions can each have the effect of an optical lens. In this way, the light signals can be refracted accordingly on both sides. In this way, an imaging optical system can be implemented.

In a further advantageous embodiment, at least one redirection region can have the effect of an optical converging lens. In this way, the light signals can converge toward a focal point.

In a further advantageous embodiment, a distance between optical main surfaces of the redirection regions can correspond to the focal lengths of the at least two redirection regions. In this way, it can be made possible that the respective focal points of the at least two redirection regions coincide.

In a further advantageous embodiment, at least one redirection region can have an optical main surface, which is at least regionally flat. In this way, a defined main plane can be generated in accordance with an optical lens. In this way, the direction of the light signals can be changed more accurately.

In a further advantageous embodiment, respective focal points of the at least two redirection regions can coincide. In this way, parallel incident light signal beams can be converted into parallel emerging light signal beams.

In a further advantageous embodiment, respective focal points of the at least two redirection regions can lie between the at least two redirection regions. In this way, the shapes of the light signals when changing direction can be preserved.

Advantageously, at least one diffractive structure can be designed as a diffractive optical element. Diffractive optical elements (DoE) can be manufactured individually and be adapted to the corresponding requirements. The effect of optical lenses can be realized with diffractive optical elements.

Advantageously, at least one redirection region can have a transmissive effect for the light signals. In this way, the light signals can radiate through the at least one redirection region.

Redirection regions that are transmissive to light signals have the advantage that the light source can be arranged on the side opposite the monitoring region. As a result, there are no zones that are obscured by the transmitter light source.

In a further advantageous embodiment, at least one redirection region can be implemented in, at and/or on at least one substrate that is transmissive to the light signals, and/or the at least two redirection regions can be implemented on opposite sides of a substrate that is transmissive to the light signals. The substrate can be used to increase mechanical stability. Furthermore, the substrate can be used as a mechanical retainer. For example, the substrate can in particular be mounted on at least one corresponding pivot about which the former can be rotated or pivoted. The incidence of the light signals on the at least one redirection region can thus be changed, in particular set.

The substrate can advantageously be made from glass, plastic or the like, on which the respective diffractive optical element can be implemented by way of coating or removal, in particular etching or the like.

Advantageously, at least one substrate can be implemented in the form of a thin layer.

In a further advantageous embodiment, at least one focal point of at least one redirection region can lie within at least one substrate that is transmissive to the light signal and in, at and/or on which at least one redirection region is implemented. In this way, the light signal redirection device can be constructed in a more space-saving manner. The focal points of the at least two redirection regions can preferably lie within the substrate.

Advantageously, at least one redirection region with the effect of an optical lens can be arranged on the light entry side of a substrate, and/or at least one redirection region with the effect of an optical lens can be arranged on the light exit side of a substrate. In this case, at least one redirection region with the effect of an optical lens may be provided either on the light entry side or on the light exit side. Alternatively, in each case at least one redirection region with the effect of an optical lens can be provided both on the light entry side and on the light exit side.

With redirection regions with the effect of an optical lens on the light entry side, the corresponding refraction of the light signals can take place before they enter the substrate.

With redirection regions with the effect of an optical lens on the light exit side, the light signals can be directed directly into the monitoring region.

In a further advantageous embodiment, the at least two redirection regions in the beam path of the light signals can be arranged in a completely overlapping manner one behind another. In this way, the light that is redirected with the first redirection region can be directed completely onto the second redirection region.

Advantageously, the at least two redirection regions can be designed differently or identically and have direction-changing properties. In this way, the redirection of the light signals can be adjusted as required.

In a further advantageous embodiment, at least one redirection region of at least one light signal deflection device can be movable using at least one drive device. In this way, the incidence of the light signals on at least one of the redirection regions can be changed, in particular set, using the at least one drive device.

The at least two redirection regions can advantageously be driven jointly. In this way, the redirection regions can be moved together.

The at least one drive device can advantageously implement a rotating drive, a linear drive or some other type of drive, or a combination of different drives. Corresponding rotation and/or displacement movements can in this way be performed.

Advantageously, at least one drive device can have at least one motor, in particular a rotation motor, a linear motor, a linear direct current motor, a moving-coil motor, a moving-coil drive or the like, or a motor or actuator of a different type. It is possible to simply implement an electrical drive by way of electric motors.

At least one drive device can advantageously be connected directly to the at least two redirection regions, in particular to at least one substrate on which the at least two redirection regions are implemented. In this way, the at least two redirection regions can be accelerated and decelerated more quickly. The light signal redirection device according to the invention can thus be operated at a higher speed and with a longer lifetime in comparison with a conventional rotating mirror that is driven in rotation using a motor.

The at least two redirection regions, in particular the substrate on which the at least two redirection regions are implemented, can advantageously be driven in a rotating or oscillating manner. Advantageously, a rotation angle of the at least one drive device can be delimited. In this way, the redirection of the light signals onto the desired field of view can be set.

The at least two redirection regions, in particular the substrate on which the at least two redirection regions are implemented, can advantageously be arranged so as to be rotatable and/or pivotable and/or displaceable. In this way, the incidence of the light signals on the at least one redirection region can be changed by correspondingly moving the at least one redirection region relative to the transmitter light source.

The at least two redirection regions, in particular the substrate on which the at least two redirection regions are implemented, can advantageously be rotatable and/or pivotable in one dimension or in two dimensions. In this way, the direction of the light signals can be changed in one dimension or in two dimensions.

The at least two redirection regions, in particular a substrate on which the at least two redirection regions are arranged, can advantageously have at least one common pivot for rotation and/or pivoting. With a common pivot for rotation and/or pivoting, the incidence of the light signals can be changed in one spatial dimension. With two pivots for rotation and/or pivoting, a corresponding rotation or pivoting can take place in two dimensions. For example, the incidence of the light signals can be changed in two spatial dimensions. Accordingly, the monitoring region can be sampled in two dimensions. Advantageously, the at least two pivots for rotation or pivoting can extend perpendicular to one another. In this way, efficient two-dimensional sampling can be realized.

The transmission device can advantageously have at least one optical system, which is arranged between at least one transmitter light source and at least one redirection region. The optical system can be used to correspondingly shape, in particular focus and/or expand, the light signals.

Advantageously, the at least one optical system can be designed such that it is used to expand, in particular fan out, the light signals in one spatial direction. In this way, it is possible to light a correspondingly greater section of the at least one redirection region in this spatial direction. The field of view of the measurement apparatus can thus be expanded in this direction. Additionally, the expanded light signals can irradiate at least one further redirection region, which can be arranged, viewed in this spatial direction, next to the at least one redirection region used for pivoting the beam direction of the light signals. This further redirection region can be a position region of a position capturing device, with which the position, in particular pivot position, of the at least one redirection region can be ascertained. In this way, it is possible using only one transmitter light source to both sample the monitoring region and also determine the position, in particular pivot position, of the at least one redirection region.

Alternatively or additionally, the at least one optical system can be designed such that it can be used to focus the light signals in one spatial direction. In this way, the resolution of the measurement apparatuses in this spatial direction can be improved.

The spatial direction in which the light signals are expanded can advantageously be parallel to a pivot about which the at least two redirection regions can be pivoted or rotated. In this way, the monitoring region can be scanned in the spatial direction perpendicular to the pivot with the aid of the light signal redirection device.

Advantageously, at least one optical system can have at least one optical lens. The light signals can be shaped using an optical lens.

Furthermore, the object is achieved according to the invention in the light signal redirection device in that at least two redirection regions are arranged one behind another in the beam path of the light signals and at least one redirection region has at least one diffractive structure which has the effect of an optical lens.

According to the invention, the light signals are refracted with the at least one diffractive structure which has the effect of an optical lens. A beam direction of the light signals can thus be changed easily and accurately.

The light signal redirection device can advantageously be assigned to at least one transmission device of the optical measurement apparatus and/or at least one receiving device of the optical measurement apparatus. Light signals can be directed from the transmission device into the monitoring region using a light signal redirection device, which is assigned to the at least one transmission device. Reflected light signals can be redirected from the monitoring region to the at least one receiving device using a light signal redirection device, which is assigned to the at least one receiving device.

Advantageously, the at least one transmission device and the at least one receiving device can each be assigned a separate light signal redirection device. In this way, the light signal deflection devices can be operated separately. Alternatively, the light signal redirection devices for the at least one transmission device and the at least one receiving device can be coupled to one another in terms of control technology and/or mechanically. In this way, the light signal redirection devices can be coordinated with one another. A single light signal redirection device can advantageously be provided, which can be assigned to both the at least one transmission device and to the at least one receiving device. In this way, the expenditure, in particular on components, for assembly and/or adjustment, can be reduced.

In addition, the object is achieved according to the invention in the optical measurement apparatus in that at least two redirection regions are arranged one behind another in the beam path of the light signals and at least one redirection region of the at least one transmission device has at least one diffractive structure which has the effect of an optical lens.

The optical measurement apparatus, in particular at least one transmission device and/or at least one receiving device, can advantageously have at least one light signal redirection device according to the invention.

At least one light signal redirection device can advantageously be assigned to the at least one receiving device. The at least one light signal redirection device on the receiver side can be constructed and/or act according to the same principle as the at least one light signal redirection device on the transmitter side, in particular the transmission device according to the invention.

The at least one light signal redirection device on the receiver side can advantageously have at least two redirection regions which are arranged one behind another in the beam path of the light signal, wherein at least one redirection region has at least one diffractive structure which has the effect of an optical lens.

Advantageously, the at least one light signal redirection device on the receiver side can be mechanically coupled to the at least one light signal redirection device on the transmitter side. In this way, the corresponding redirection regions can be set, in particular controlled, together.

Advantageously, at least two redirection regions arranged one behind another according to the invention for the transmission device and at least two redirection regions arranged one behind another according to the invention for the receiving device can be implemented on a common substrate. In this way, the redirection regions can be produced together. In addition, the redirection regions can be moved simply with the aid of the substrate and a corresponding drive device.

Alternatively, the at least one light signal redirection device on the receiver side can be operated separately from the at least one light signal redirection device on the transmitter side. The at least one light signal redirection device on the receiver side and the at least one light signal redirection device on the transmitter side can also operate according to different principles.

Furthermore, the object is achieved according to the invention in the method in that the direction of the light signals is changed with the aid of at least two redirection regions which are arranged one behind another in the beam path of the light signals, wherein at least one of the redirection regions has at least one diffractive structure which has the effect of an optical lens.

According to the invention, at least one diffractive structure with the effect of an optical lens is used in order to change the beam direction of the light signals.

In an advantageous refinement of the method, at least one redirection region and at least one transmitter light source can be moved relative to one another in order to change the incidence of the light signals on the at least one redirection region. In this way, a corresponding change in the beam direction of the light signal can be attained.

Moreover, the features and advantages indicated in connection with the transmission device according to the invention, the light signal redirection device according to the invention, the measurement apparatus according to the invention, and the method according to the invention, and the respective advantageous configurations thereof apply here in a mutually corresponding manner and vice versa. The individual features and advantages can of course be combined with one another, wherein further advantageous effects that go beyond the sum of the individual effects may emerge.

### BRIEF DESCRIPTION OF THE DRAWINGS

Further advantages, features and details of the invention are apparent from the following description, in which exemplary embodiments of the invention will be explained in greater detail with reference to the drawings. A person skilled in the art will also expediently consider individually the features that have been disclosed in combination in the drawing, the description and the claims and combine them to form further meaningful combinations. Schematically, in the drawings,

FIG. 1 shows a front view of a vehicle having an optical measurement apparatus, which is connected to a driver assistance system;

FIG. 2 shows the optical measurement apparatus with the driver assistance system from FIG. 1;

FIG. 3 shows a transmitter light signal redirection device according to a first exemplary embodiment of a transmission device of the measurement apparatus from FIG. 2, with a pivot for deflecting transmitted light signals in one dimension, in a central position, in a view in the direction of a pivot, with which the light signal redirection device can be pivoted;

FIG. 4 shows the light signal redirection device from FIG. 3 in a deflection position;

FIG. 5 shows a light signal redirection device according to a second exemplary embodiment of a transmission device of the measurement apparatus from FIG. 2, with two pivots for deflecting transmitted light signals in two dimensions, in a view in the direction of a first pivot, with which the light signal redirection device can be pivoted in a first dimension.

In the figures, identical components are provided with the same reference signs.

### EMBODIMENT(S) OF THE INVENTION

FIG. 1 illustrates a vehicle 10, for example a passenger vehicle, in the front view. The vehicle 10 has an optical measurement apparatus 12, for example a laser scanner. The optical measurement apparatus 12 is arranged for example in a front bumper of the vehicle 10. The vehicle 10 furthermore has a driver assistance system 14, with which the vehicle 10 can be operated autonomously or partially autonomously. The optical measurement apparatus 12 is functionally connected to the driver assistance system 14, with the result that information that can be acquired with the measurement apparatus 12 can be transmitted to the driver assistance system 14. The measurement apparatus 12 can be used to monitor a monitoring region 16, located, in the exemplary embodiment shown, in the driving direction in front of the motor vehicle 10, for objects 18. The measurement apparatus 12 can also be arranged at a different location on the vehicle 10, possibly oriented differently. A plurality of measurement apparatuses 12 can also be provided.

The measurement apparatus 12 operates in accordance with a time-of-flight method. For this purpose, light signals 20, for example in the form of laser pulses, are transmitted into the monitoring region 16. For example, light signals 22 reflected at an object 18 that may be present are received by the measurement apparatus 12. A distance of the object 18 from the measurement apparatus 12 is ascertained from a time of flight between the transmission of the light signals 20 and the receipt of the reflected light signals 22. The beam direction of the light signals 20 is pivoted over the monitoring region 16 during the measurements. The monitoring region 16 is sampled in this way. A direction of the object 18 relative to the measurement apparatus 12 is ascertained from the beam direction of the light signals 20, which are reflected at the object 18.

The measurement apparatus 12 comprises a transmission device 24, a receiving device 26, and an electronic control and evaluation device 28.

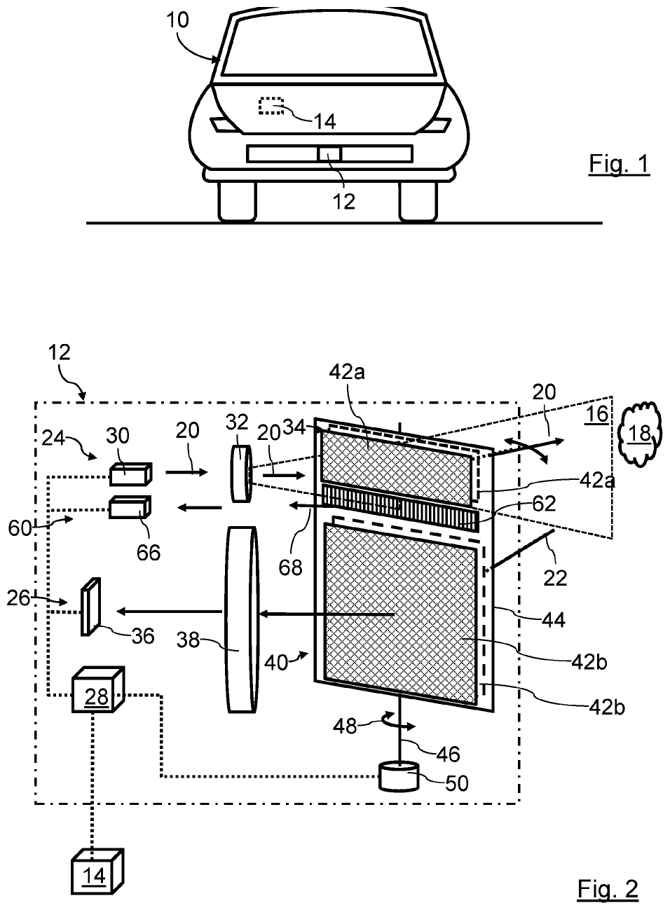

The transmission device 24, which is shown by way of example in FIG. 2, comprises a transmitter light source 30, an optical system in the form of a transmitter lens 32, and a transmitter light signal redirection device 34.

The receiving device 26 comprises an optical receiver 36, a receiver lens 38, and a receiver light signal redirection device 40.

The transmitter light source 30 has, for example, one laser. Pulsed laser signals can be generated in the form of light signals 20 using the transmission light source 30.

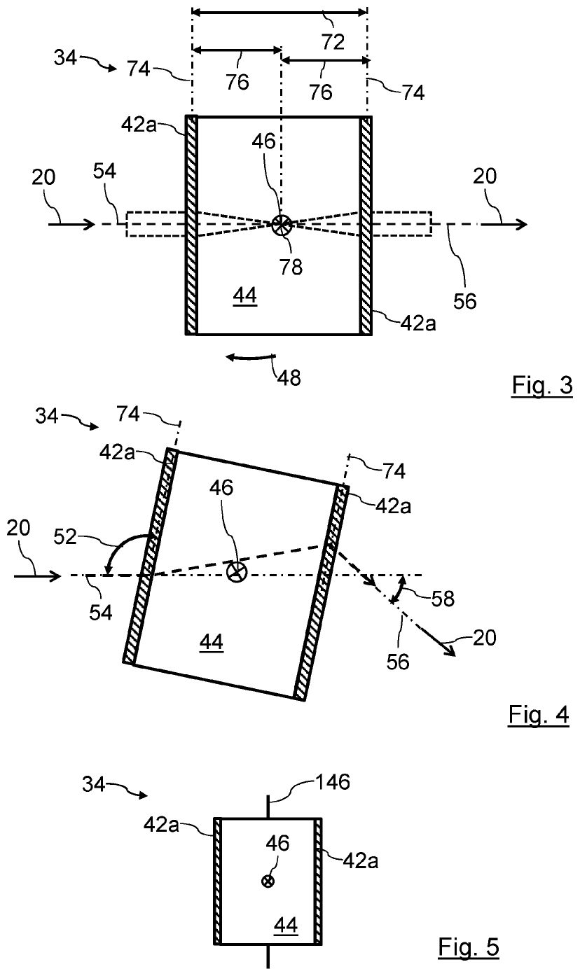

The light signals 20 can be expanded in a direction transversely to their beam direction using the transmitter lens 32. This is indicated in FIG. 2 by a dashed trapezoid. In the exemplary embodiment shown, the light signals 20 are expanded using the transmitter lens 32 in the direction of a pivot 46, for example in the vertical direction. In FIGS. 3 to 5, the pivot 46 is indicated as a circle with a cross.

The transmitter light signal redirection device 34 is located in the beam path of the transmitter light source 30 downstream of the transmitter lens 32. With the aid of the transmitter light signal redirection device 34, the beam direction of the light signals 20 can be pivoted in one dimension of a plane. For example, the pivot plane extends perpendicular to the direction in which the light signals 20 are expanded using the transmitter lens 32, that is to say for example horizontally. In this way, the monitoring region 16 can be sampled in the horizontal direction using light signals 20 that follow one behind another.

Reflected light signals 22 are redirected, using the receiver light signal redirection device 14, from the monitoring region 16 onto the receiver lens 38. The reflected light signals 22 are imaged onto the receiver 36 using the receiver lens 38.

The receiver 36 is designed, for example, as a CCD chip, array, photodiode or a detector of a different type for receiving the reflected light signals 22 in the form of laser pulses. The received light signals 22 are converted to electronic signals using the receiver 36. The electronic signals are transmitted to the control and evaluation device 28.

The transmission device 24 and the receiving device 26 are controlled using the control and evaluation device 28. Furthermore, the electronic signals obtained from the received light signals 22 are evaluated using the control and evaluation devices 28. The time of flight and, on the basis thereof, the distance of the object 18 at which the light signals 22 have been reflected are ascertained using the control and evaluation devices 28. In addition, the direction of the object 18 is ascertained using the control and evaluation devices 28.

In FIGS. 3 and 4, a transmitter light signal redirection device 34 according to a first exemplary embodiment is shown. FIG. 3 shows the transmitter light signal redirection device 34 in a central position. FIG. 4 shows the transmitter light signal redirection device 34 in an exemplary deflection position.

The transmitter light signal redirection device 34 comprises, for example, two transmitter redirection regions 42a, each in the form of a diffractive structure. This is also shown in particular in FIGS. 3 and 4. The diffractive optical structures are implemented, for example, as what are known as diffractive optical elements. The transmitter redirection regions 42a each have the effect of optical converging lenses. The transmitter redirection regions 42a are implemented, for example, on opposite sides of a rectangular, flat substrate 44. The substrate 44 is, for example, a glass plate or plastics plate, which is transmissive to the light signals 20. The substrate 44 with the transmitter redirection regions 42a can also be implemented as a thin film. One of the transmitter redirection regions 42a is arranged on the side of the substrate 44 facing away from the transmitter lens 32. The other transmitter redirection region 42a is arranged on the side of the substrate 44 facing the transmitter lens 32. The transmitter redirection regions 42a each extend as a strip almost over the entire width of the substrate 44 transversely to the pivot 46. The two transmitter redirection regions 42a are arranged in the beam path of the light signals 20 in a completely overlapping manner one behind another.

A distance 72 between optical main planes 74 of the transmitter redirection regions 42a corresponds to the sum of the focal lengths 76 of the transmitter redirection regions 42a. The respective focal points 78 of the transmitter redirection regions 42a coincide. The focal points 78 are located in the substrate 44 between the transmitter redirection regions 42a. In the exemplary embodiment shown, the focal lengths 76 of the transmitter redirection regions 42a shown are, for example, identical. The focal lengths 76 can also differ. Furthermore, the focal points 78 lie on the pivot 46 in the central position of the transmission light signal redirection device 34 shown in FIG. 3. The focal points 78 can also lie outside of the pivot 46.

The substrate 44 is mounted on the pivot 46. The pivot 46, in turn, is driven by a motor 50, so that the substrate 44 and, with it, the transmitter redirection regions 42a can be pivoted back and forth about the pivot 46. The pivoting direction of the substrate 44 and thus of the transmitter redirection regions 42a is indicated in FIGS. 2 and 3 by a double-headed arrow 48.

The motor 50 is connected in a controllable manner to the control and evaluation device 28.

As is also shown in FIG. 3, the transmitter redirection regions 42a are located in the beam path of the light signals 20 of the transmission device 24. Light signals 20 are initially refracted in dependence on their incidence on the transmitter redirection region 42a facing the transmitter lens 32 with the effect of a corresponding converging lens and are diverted toward the center of the light beam of the light signal 20. The light bundle of the light signals 20 is indicated by dashed lines in FIG. 3. The incidence is defined by an angle of incidence 52 indicated in FIG. 4. The angle of incidence 52 is the angle between an incidence beam direction 54 of the light signals 20 and the main plane 74 of the front transmitter redirection region 42a.

The diverted light signals 20 radiate through the substrate 44 and are diverted again with the rear transmitter redirection region 42a on the side facing away from the transmitter lens 32 with the effect of a corresponding converging lens. Overall, the light signals 20 are thus redirected by a diversion angle 58, designated in FIG. 4, between the incidence beam direction 54 and an exit beam direction 56 of the redirected light signals 20.

In order to change the diversion angle 58, the substrate 44 with the transmitter redirection regions 42 is pivoted about the pivot 46, which leads to a change in the angle of incidence 52. By pivoting the substrate 44 with the transmitter redirection regions 42, the exit beam direction 56 of the light signals 20 in the monitoring region 16 is pivoted. The monitoring region 16 can be sampled with the aid of the pivotable transmitter redirection regions 42a.

The receiver light signal redirection device 40 is constructed analogously to the transmitter light signal redirection device 34. The receiver light signal redirection device 40 comprises, as is shown in FIG. 2, two receiver redirection regions 42b. The receiver redirection regions 42b are diffractive structures, for example diffractive optical elements, which each have the effect of an optical converging lens.

In the exemplary embodiment shown, the receiver redirection regions 42b are implemented on opposite sides of the same substrate 44, on which the transmitter redirection regions 42a are also implemented. The receiver redirection regions 42b extend almost over the entire width of the substrate 44 transversely to the pivot 46. The extent of the receiver redirection regions 42b in the direction of the pivot 46 is greater than the corresponding extent of the transmitter redirection regions 42a. The two receiver redirection regions 42b are arranged in the beam path of the reflected light signals 22 in a completely overlapping manner one behind another.

In the exemplary embodiment shown, the transmission light signal redirection device 34 and the receiver light signal redirection device 40 are mechanically coupled to one another with the aid of the common substrate 44. In this way, the transmission redirection regions 42a and the receiver redirection regions 42b can be pivoted together with the pivot 46. To this end, only a single motor 50 is necessary.

In an alternative exemplary embodiment (not shown), the transmitter redirection regions 42a and the receiver redirection regions 42b can be implemented separately from one another, for example on separate substrates. The separate substrates can be connected to one another mechanically, for example on a common pivot, and be jointly driven. The transmitter redirection regions 42a and the receiver redirection regions 42b can also be mechanically separate from one another. In this case, the transmitter light signal redirection device 34 comprises two transmitter redirection regions 42a and a dedicated drive device. The receiver light signal redirection device 40 likewise comprises two receiver redirection regions 42b and a dedicated drive device.

The receiver redirection regions 42b are designed such that reflected light signals 22 coming from the monitoring region 16 are directed using the former in each pivot position of the receiver redirection regions 42b, or the substrate 44, onto the receiver lens 38. The receiver lens 38 is used to focus the redirected reflected light signals 22 onto the receiver 36.

The measurement apparatus 12 moreover has a position capturing device 60. The position capturing device 60 can be used to ascertain a pivot position of the substrate 44 and thus of the transmitter light signal redirection device 34 and the receiver light signal redirection devices 40.

The position capturing device 60 comprises a position region 62 for example in the form of a diffractive structure, for example a diffractive optical element, and an optical position detector 66.

The position region 62 is arranged on the side of the substrate 44 facing the transmission light source 30. The position region 62 is located, viewed in the direction of the pivot 46, for example between the corresponding transmitter redirection region 42a and the corresponding receiver redirection region 42b. The position region 62 extends, in the form of a strip, by way of example perpendicular to the pivot 46 almost over the entire width of the substrate 44. The position region 62 is arranged sufficiently close to the corresponding transmitter redirection region 42 so that part of the light signal 20, which has been fanned out using the transmitter lens 32, as shown in FIG. 2, is incident on the position region 62.

The diffractive structure of the position region 62 is designed such that light signals 20 that are incident on the position region 62 are encoded in dependence on the angle of incidence 52 of the light signals 20 on the position region 62. The encoding here characterizes the respective angle of incidence 52. In the exemplary embodiment shown, the incident part of the light signals 20 is encoded and reflected as position light signals 68 and transmitted to the position detector 66.

The position detector 66 is arranged, by way of example, at the same height next to the transmitter light source 30. The position detector 66 can be designed for example as an individual detector, a line-scan detector or an area-scan detector. For this purpose, for example a CCD chip, a photodiode or the like can be used.

The encoded light signals 68 are converted to electrical position signals using the position detector 66 and transmitted to the control and evaluation devices 28. The control and evaluation devices 28 are used to ascertain, from the electrical position signals, the pivot deflection of the position region 62 and thus the pivot deflection of the substrate 44, of the transmitter redirection regions 42a and of the receiver redirection regions 42b. It is thus possible to ascertain a pivot position of the transmitter light redirection device 34 and the receiver light signal redirection device 40 with the aid of the capturing device 60.

In an exemplary embodiment (not shown), the position region 62 can be designed for transmission rather than for the reflection of the light signals. In this case, the position detector 66 is disposed on the side of the position region 62 that lies opposite the transmitter light source 30.

During the operation of the measurement apparatus 12, pulsed light signals 20 are transmitted using the transmitter light source 30 through the transmitter lens 32 onto the transmitter redirection region 42a, of the transmitter light signal redirection device 34, facing the transmitter lens 32 and the position region 62.

The light signals 20 are transmitted into the monitoring region 16 using the transmitter light signal redirection device 34 in dependence on the pivot position of the substrate 44, that is to say in dependence on the angle of incidence 52. The light signals 22 reflected at the object 18 are directed onto the receiver lens 38 using the receiver light signal redirection device 40. The reflected light signals 22 are focused onto the receiver 36 using the receiver lens 38. Using the receiver 36, the reflected light signals 22 are converted to electrical signals and transmitted to the control and evaluation device 28. Using the control and evaluation devices 28, the time of flight of the light signals 20 and of the corresponding reflected light signals 22 is ascertained and a distance of the captured object 18 from the measurement apparatus 12 is determined therefrom.

Furthermore, the position region 62 is used to encode the portion of the light signals 20 that is incident thereon and is transmitted to the position detector 66 as position light signals 68. The pivot position of the transmitter light signal redirection device 34 and the receiver light signal redirection devices 40 is determined from the position light signals 68. Based on the pivot position, the direction of the captured object 18 relative to the measurement apparatus 12 is ascertained.

During the measurement, the pivot 46 is rotated by the motor 50 and consequently the substrate 44 with the transmitter redirection regions 42a and the receiver redirection regions 42b is pivoted back and forth. In this way, pulsed light signals 20 that have been emitted one after the other undergo different diversions into the monitoring region 16. In this way, the monitoring region 16 is scanned with the pulsed light signals 20.

FIG. 5 shows a transmitter light signal redirection device 34 according to the second exemplary embodiment. Those elements which are similar to those of the first exemplary embodiment from FIGS. 2 to 4 are provided with the same reference signs. In contrast to the first exemplary embodiment, the transmitter light signal redirection device 34 according to the second exemplary embodiment has a second pivot 146 about which the substrate 44 and thus the transmitter light signal redirection device 34 and the receiver light signal redirection device 40 can be pivoted in a second dimension. The second pivot 146 extends perpendicular to the first pivot 46. Overall, it is thus possible with the aid of the transmitter light signal redirection device 34 and the receiver light signal redirection device 40 to sample the monitoring region 16 in a spatially resolved manner in two dimensions.

1. A transmission device for an optical measurement apparatus for capturing objects in a monitoring region, the transmission device comprising:
at least one transmitter light source for sending light signals;
at least one light signal redirection device for redirecting the light signals into at least one monitoring region of the optical measurement apparatus,
wherein the at least one light signal redirection device has at least one redirection region that acts on the light signals in dependence on an incidence of the light signals so as to change their direction; and
at least one drive device, with which the at least one light signal redirection device is moved to change an incidence of the light signals on the at least one redirection region,
wherein at least two redirection regions are arranged one behind another in the beam path of the light signals and at least one redirection region has at least one diffractive structure which has the effect of an optical lens.

2. The transmission device as claimed in claim 1, wherein the at least two redirection regions each have the effect of an optical lens.

3. The transmission device as claimed in claim 1, wherein at least one redirection region has the effect of an optical converging lens.

4. The transmission device as claimed in claim 1, wherein a distance between optical main surfaces of the redirection regions corresponds to the focal lengths of the at least two redirection regions.

5. The transmission device as claimed in claim 1, wherein at least one redirection region has an optical main surface which is at least regionally flat.

6. The transmission device as claimed in claim 1, wherein respective focal points of the at least two redirection regions coincide.

7. The transmission device as claimed in claim 1, wherein respective focal points of the at least two redirection regions lie between the at least two redirection regions

8. The transmission device as claimed in claim 1, wherein at least one redirection region is implemented in, at and/or on at least one substrate that is transmissive to the light signals, and/or the at least two redirection regions are implemented on opposite sides of a substrate that is transmissive to the light signals.

9. The transmission device as claimed in claim 1, wherein at least one focal point of at least one redirection region lies within at least one substrate that is transmissive to the light signals and in, at and/or on which at least one redirection region is implemented.

10. The transmission device as claimed in claim 1, wherein the at least two redirection regions in the beam path of the light signals are arranged in a completely overlapping manner one behind another.

11. The transmission device as claimed in claim 1, wherein at least one redirection region of at least one light signal redirection device is movable using at least one drive device.

12. The transmission device as claimed in claim 1, wherein at least one redirection region is arranged so as to be rotatable and/or pivotable and/or displaceable in at least one dimension.

13. A light signal redirection device for an optical measurement apparatus for capturing objects in a monitoring region, wherein the light signal redirection device comprising:
at least one redirection region that acts on light signals in dependence on an incidence of the light signals so as to change their direction,
wherein at least two redirection regions are arranged one behind another in the beam path of the light signals and at least one redirection region has at least one diffractive structure which has the effect of an optical lens.

14. An optical measurement apparatus for capturing objects in a monitoring region, comprising:
at least one transmission device for sending light signals;
at least one receiving device, with which light signals that have been reflected at objects that may be present in the monitoring region can be received;
at least one control and evaluation device, with which the at least one transmission device and the at least one receiving device can be controlled and with which light signals received can be evaluated;
at least one light signal redirection device for redirecting light signals, wherein the at least one light signal redirection device has at least one redirection region that can act on the light signals in dependence on an incidence of the light signals so as to change their direction; and
at least one drive device, with which at least one redirection region is moved to change an incidence of the light signals on the at least one redirection region,
wherein at least two redirection regions are arranged one behind another in the beam path of the light signals and at least one redirection region has at least one diffractive structure which has the effect of an optical lens.

15. A method for operating an optical measurement apparatus for capturing objects in a monitoring region, comprising:
generating light signals with at least one transmitter light source;
transmitting the light signals into the monitoring region; and
receiving light signals reflected in the monitoring region, by at least one receiver,
wherein respective directions of at least some of the light signals with at least one redirection region of at least one light signal redirection device are changed in dependence on an incidence of the light signals on the at least one redirection region,
wherein the at least one redirection region is moved for setting an incidence of the light signals on the at least one redirection region using at least one drive device, and
wherein the direction of the light signals is changed with the aid of at least two redirection regions which are arranged one behind another in the beam path of the light signals, wherein at least one of the redirection regions has at least one diffractive structure which has the effect of an optical lens.
